(19) United States
(12) Patent Application Publication
(10) Pub. No.: US 2025/0061362 A1
(43) Pub. Date: Feb. 20, 2025

(54) METHOD AND SYSTEM FOR MØLMER-SØRENSEN GATE TOMOGRAPHY PROTOCOL

(71) Applicant: IonQ, Inc., College Park, MD (US)

(72) Inventor: Erik NIELSEN, College Park, MD (US)

(21) Appl. No.: 18/802,808

(22) Filed: Aug. 13, 2024

Related U.S. Application Data
(60) Provisional application No. 63/519,404, filed on Aug. 14, 2023.

(51) Int. Cl. G06N 10/20; G06N 10/70

(52) U.S. Cl. CPC G06N 10/20; G06N 10/70

(57) ABSTRACT

Aspects of the present disclosure relate generally to systems and methods for use in the implementation and/or operation of quantum information processing (QIP) systems, and more particularly, to the use of quantum process imperfection feedback for quantum process estimation in quantum elements and/or quantum computations in QIP systems.

### CLAIM OF PRIORITY

The present application claims priority to U.S. Provisional Application No. 63/519,404, filed on Aug. 14, 2023, and hereby incorporated herein by reference.

### TECHNICAL FIELD

Aspects of the present disclosure relate generally to systems and methods for use in the implementation and/or operation of quantum information processing (QIP) systems.

### BACKGROUND

Trapped atoms are one of the leading implementations for quantum information processing or quantum computing. Other implementations include those based on superconducting qubits or photonic qubits, for example. Atomic-based qubits may be used as quantum memories, as quantum gates in quantum computers and simulators, and may act as nodes for quantum communication networks. Qubits based on trapped atomic ions enjoy a rare combination of attributes. For example, qubits based on trapped atomic ions have very good coherence properties, may be prepared and measured with nearly 100% efficiency, and are readily entangled with each other by modulating their Coulomb interaction with suitable external control fields such as optical or microwave fields. These attributes make atomic-based qubits attractive for extended quantum operations such as quantum computations or quantum simulations.

It is therefore important to develop new techniques that improve the design, fabrication, implementation, and/or control of different QIP systems used as quantum computers or quantum simulators, and particularly for those QIP systems that handle operations based on atomic-based qubits.

### SUMMARY

The following presents a simplified summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

According to various aspects of the disclosure, a computer-implemented method is provided. The method includes obtaining estimates of quantum process imperfections in a quantum Mølmer-Sørensen (MS) gate by running on a quantum computer (QC) a plurality of circuit families configured to evaluate the quantum process. Each of the circuit families includes a number of circuits that each include a core sub-circuit for determining a particular type of quantum process imperfection bookended by a preparation sub-circuit and a measure sub-circuit. Each of the circuits in a respective one of the circuit families differs from other circuits in that family based on including a different number of repetitions of the core sub-circuit. The method further includes calibrating the quantum process responsive to the estimates of quantum process imperfections in the quantum MS gate to reduce the quantum process imperfections.

According to various other aspects of the disclosure, a quantum information processing (QIP) system is provided. The QIP system includes at least one laser. The QIP system further includes a controller operatively coupled to the laser. The controller is configured to obtain estimates of quantum process imperfections in a quantum Mølmer-Sørensen (MS) gate by running on the QIP system a plurality of circuit families configured to evaluate the quantum process. Each of the circuit families includes a number of circuits that each include a core sub-circuit for determining a particular type of quantum process imperfection bookended by a preparation sub-circuit and a measure sub-circuit. Each of the circuits in a respective one of the circuit families differs from other circuits in that family based on including a different number of repetitions of the core sub-circuit. The controller is further configured to calibrate the quantum process by controlling the at least one laser responsive to the estimates of quantum process imperfections in the quantum MS gate to reduce the quantum process imperfections.

According to still other aspects of the disclosure, a computing system is provided. The computer processing system includes at least one laser. The computer processing system further includes a controller operatively coupled to the laser. The controller is configured to obtain estimates of quantum process imperfections in the quantum MS gate representative of quantum process imperfections in a quantum Mølmer-Sørensen (MS) gate by running on a quantum computer (QC) a plurality of circuit families configured to evaluate the quantum process. Each of the circuit families includes a number of circuits that each include a core sub-circuit for determining a particular type of quantum process imperfection bookended by a preparation sub-circuit and a measure sub-circuit. Each of the circuits in a respective one of the 5 circuit families differs from other circuits in that family based on including a different number of repetitions of the core sub-circuit. The controller is further configured to calibrate the quantum process by controlling the at least one laser responsive to the estimates of quantum process imperfections in the quantum MS gate to reduce the quantum process imperfections.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which.

FIG. 1 illustrates a view of atomic ions in a linear crystal or chain, in accordance with example aspects of this disclosure.

FIG. 2 illustrates an example of a quantum information processing (QIP) system, in accordance with example aspects of this disclosure.

FIG. 3 illustrates an example of a computer device, in accordance with example aspects of this disclosure.

FIG. 4 illustrates an exemplary overview of MS Tomography, in accordance with example aspects of this disclosure.

FIG. 5 illustrates an example circuit of a circuit family, in accordance with example aspects of this disclosure.

FIGS. 6-9 illustrate an example of a quantum process estimation method for a QIP system, in accordance with example aspects of this disclosure.

FIG. 10 illustrate an example of a description of definitions of 5 circuit families, in accordance with example aspects of this disclosure.

FIG. 11 illustrate example methods for processing circuit outcome histograms for each family, in accordance with example aspects of this disclosure.

FIGS. 12-14 illustrate an example of processed data, in accordance with example aspects of this disclosure.

### DETAILED DESCRIPTION

In quantum computers (QCs), Mølmer-Sørensen (MS) gates are commonly used to entangle the quantum states of multiple ions in an ion trap based quantum computing. Estimating the actual (noisy) quantum process performed by a MS gate is useful for calibrating the gate and assessing the performance of the hardware that implements the gate. General procedures such as gate set tomography can estimate a noisy quantum process but at a high cost because these procedures make minimal assumptions about the type of noise afflicting the system. Other procedures, such as randomized benchmarking, offer lower-cost alternatives but at the price of only estimating a single average fidelity of the gate, which is not very useful for calibration.

The present disclosure recognizes and addresses the issue of estimating the quantum process performed by a MS gate in QCs and proposes quantum process estimation systems and methods in QCs.

In various aspects, a method for quantum process estimation is proposed using a MS gate tomography protocol. The MS gate tomography protocol can efficiently estimate the errors on a MS gate when these errors are small and arise solely from several specific types of noise. In an aspect, the MS gate tomography protocol is a two-qubit or two-quantum-element protocol that applies to an entanglement of, for example, two-qubits.

In various aspects, imperfections in an MS gate arising from (1) over-rotation or under-rotation (on-axis angle miscalibration), (2) spin-phase offsets (axis misalignment in the X-Y plane), and (3) light-shifts may be diagnosed by the MS tomography protocol using relatively few circuits compared to other methods. For example, MS tomography in accordance with various aspects can require around 20 circuits whereas a similar GST application would require around 200.

In various aspects, the MS tomography protocol may be implemented by running a plurality of “families” of circuits. Each circuit family includes the same “core” sub-circuit repeated a different number of times and bookended by the same “preparation” and “measure” sub-circuits. In various aspects, 4 different core-circuit repetitions may be used, and so there are 4 circuits per family and 20 circuits total in the case of using 5 families as described herein. Other numbers of core-circuit repetitions than 4 and less than all of the 4 circuits per family may be used in other variations depending on the types of errors intended to be detected and corrected. For example, in an aspect, one circuit family may be used, with multiple circuits in that family, in order to detect one particular type of error. In other aspects, two or more circuit families may be used.

The core, preparation, and measurement circuits are chosen so that their outcomes are sensitive to different linear combinations of the types of error listed above. The outcome counts of the circuits are processed by fitting multiple lines to multiple linear combinations of circuit outcome frequencies, and applying a final linear transformation to the results. The result is an estimate for each of the error types listed above, e.g., (1) over-rotation or under-rotation, (2) spin-phase offsets, and (3) light-shifts.

Further, the quantum process estimation approach in accordance with this disclosure can be applicable to multiple types of quantum information processing (QIP) systems and qubit technologies. While various aspects of the quantum process estimation approach are described with reference to a QIP system based on trapped-atom qubits, the disclosure is not limited in that respect. Indeed, the quantum process estimation approach in accordance with this disclosure can be used in other types of QIP systems based on solid-state qubits. Additionally, while described with reference to qubits, the quantum process estimation approach of this disclosure can in some cases be implemented for other types of quantum devices, such as qudit devices.

It is to be appreciated that aspects of the present disclosure improve the functioning of a computing system such as a QC by estimating the quantum process implemented by the computer elements of the QC including in some circumstances the stored information elements (qubits) themselves. In this way, optimal performance may be achieved by a QC due to a stable, properly calibrated environment.

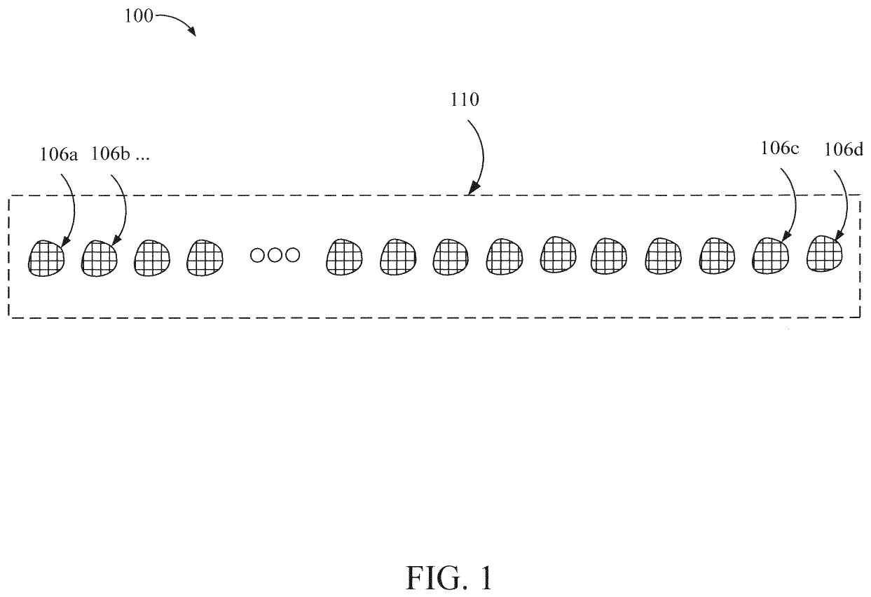

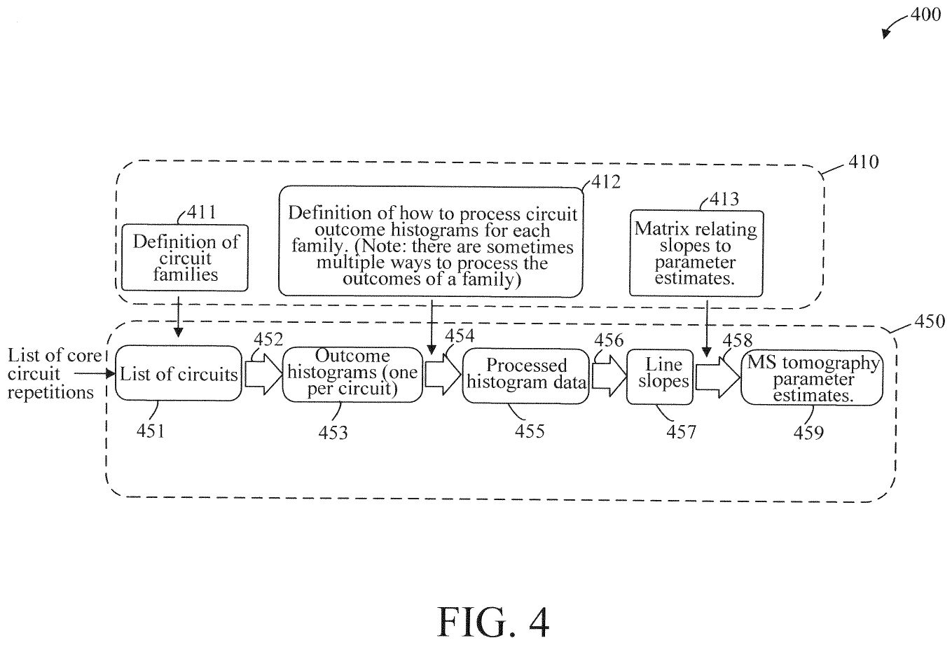

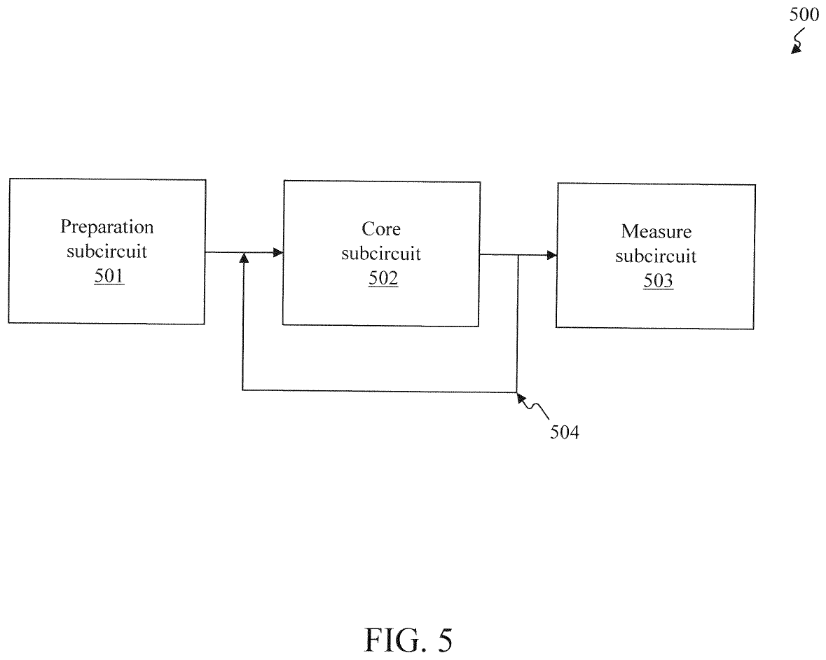

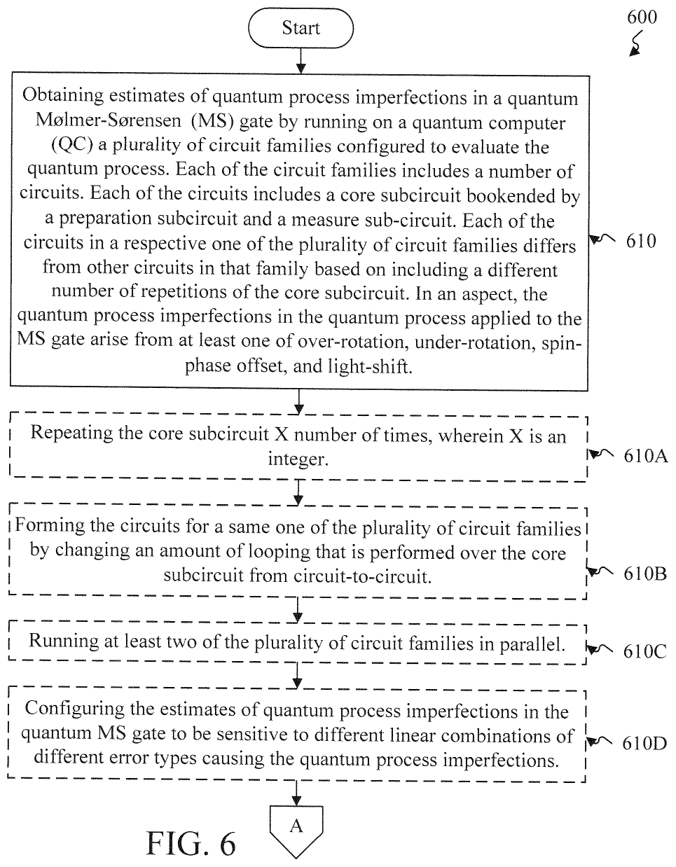

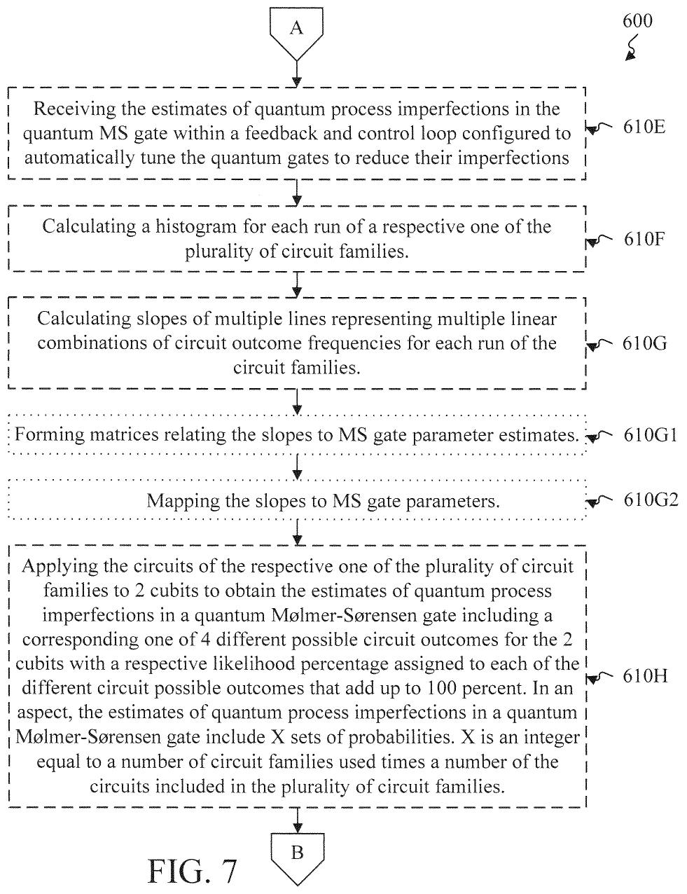

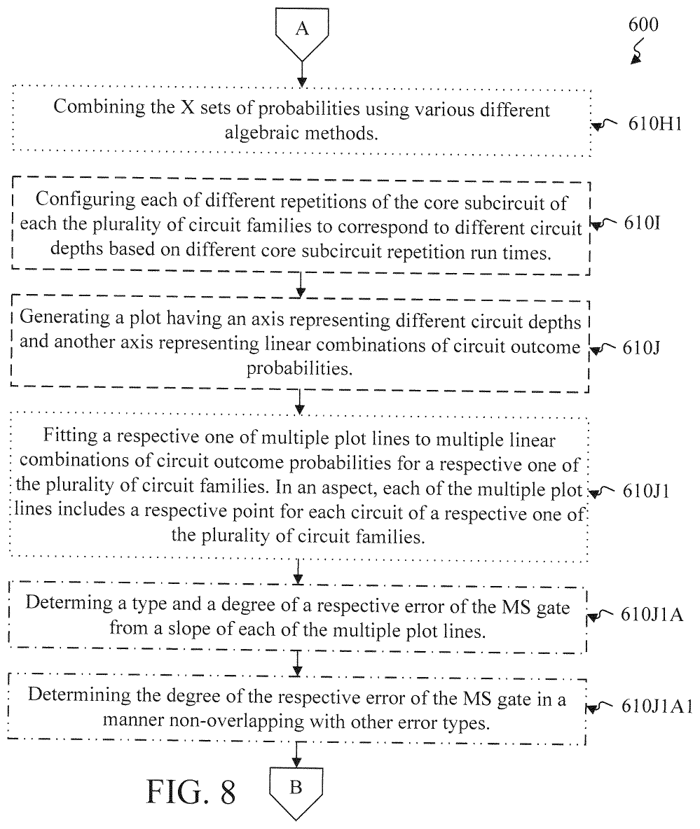

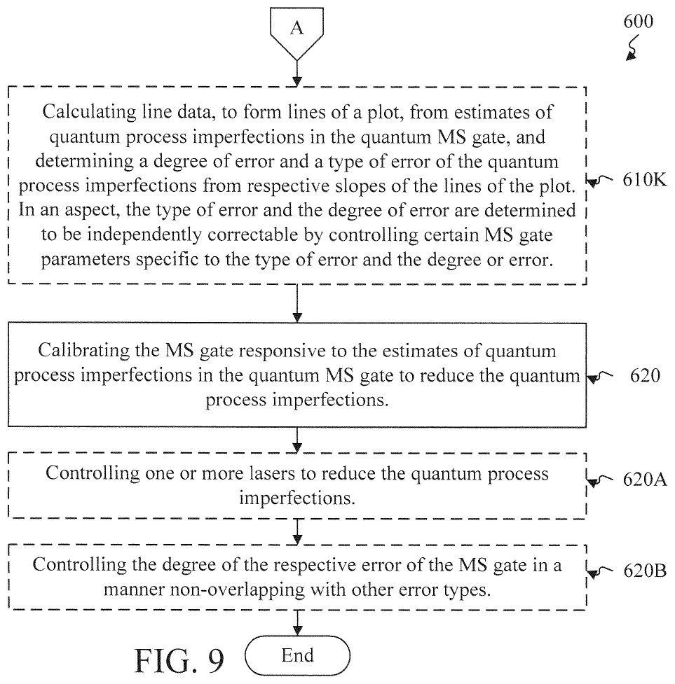

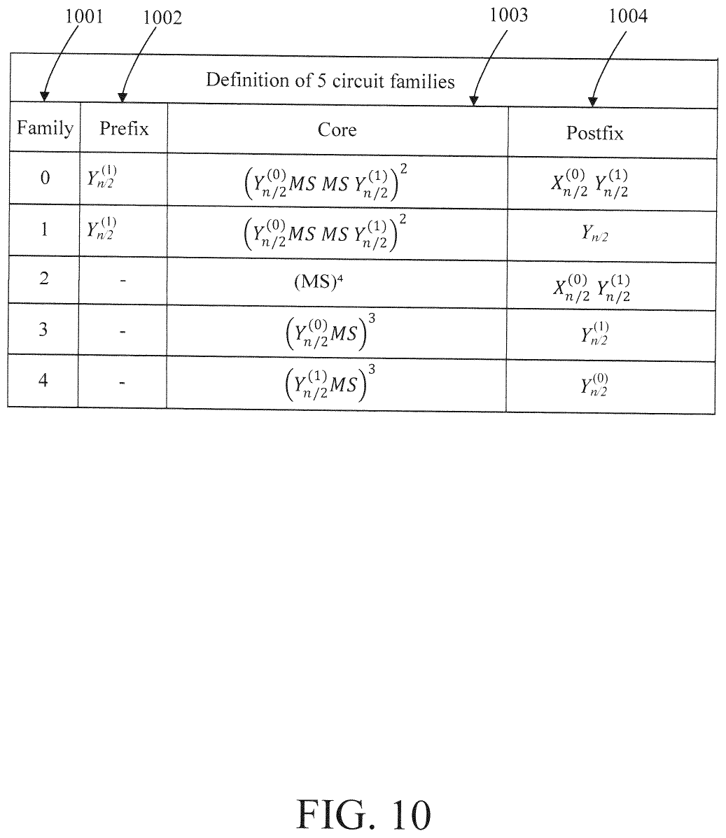

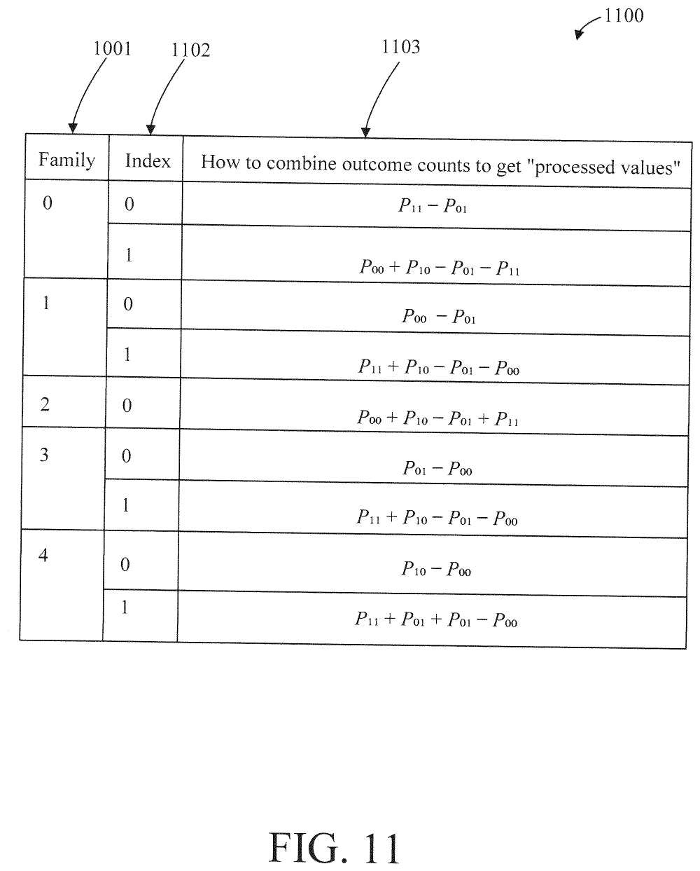

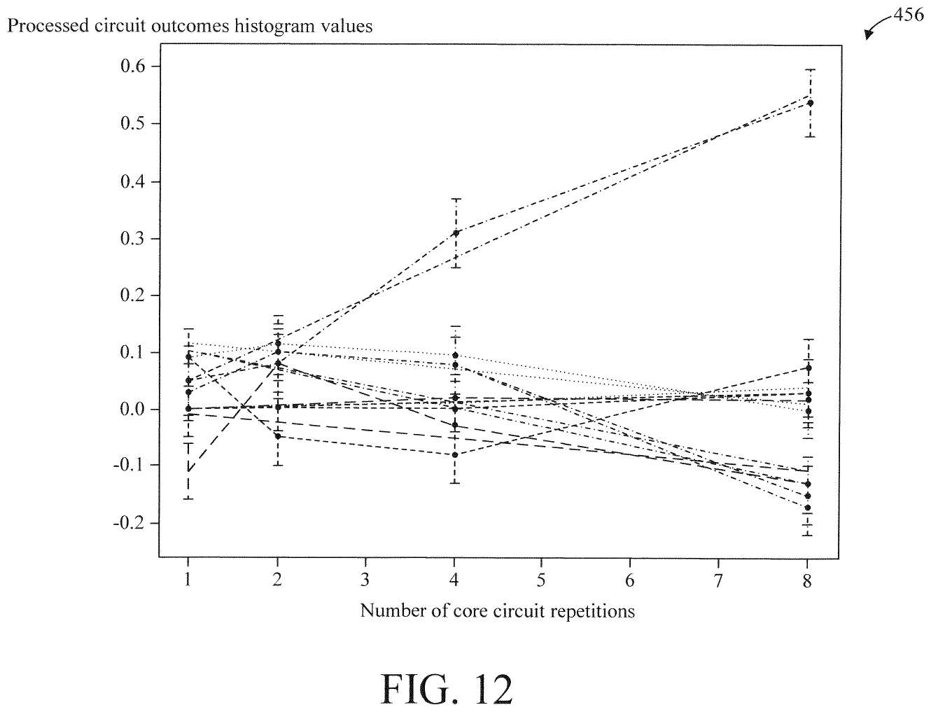

Solutions to the issues described above are explained in more detail in connection with FIGS. 1-13, with FIGS. 1-3 providing a description of example QIP systems or quantum computers, and more specifically, of atomic-based QIP systems or quantum computers, FIG. 4 providing a description of an overview of MS Tomography, FIG. 5 providing a description of an example circuit program, FIGS. 6-9 providing a description of an example method for quantum process estimation in a QIP system, FIG. 10 providing a description of an example definition of 5 circuit families, FIG. 11 providing a description of an example method for processing circuit outcome histograms for each family, and FIGS. 12-14 providing an example of processed data, in accordance with various example aspects of the present disclosure.

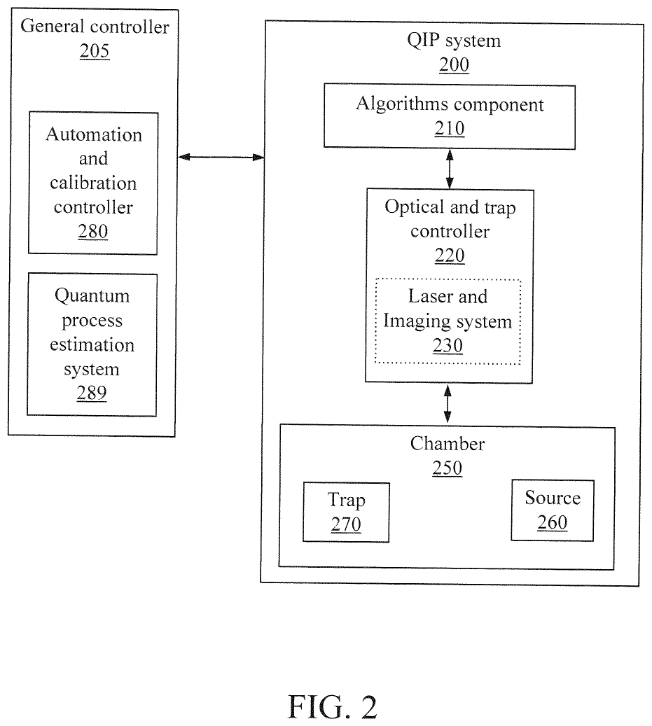

FIG. 1 shown below illustrates a diagram 100 with multiple atomic ions 106 (e.g., atomic ions 106a, 106b, . . . , 106c, and 106d) trapped in a linear crystal or chain 110 using a trap (the trap can be inside a vacuum chamber as shown in FIG. 2). The trap may be referred to as an ion trap. The ion trap shown may be built or fabricated on a semiconductor substrate, a dielectric substrate, or a glass die or wafer (also referred to as a glass substrate). The atomic ions 106 may be provided to the trap as atomic species for ionization and confinement into the chain 110.

In the example shown in FIG. 1, the trap includes electrodes for trapping or confining multiple atomic ions into the chain 110 that are laser-cooled to be nearly at rest. The number of atomic ions (N) trapped can be configurable and more or fewer atomic ions may be trapped. The atomic ions can be Ytterbium ions (e.g., ^{171Yb+} ions), for example. The atomic ions are illuminated with laser (optical) radiation tuned to a resonance in ^{171Yb+} and the fluorescence of the atomic ions is imaged onto a camera or some other type of detection device. In this example, atomic ions may be separated by about 5 microns (μm) from each other, although the separation may be smaller or larger than 5 μm. The separation of the atomic ions is determined by a balance between the external confinement force and Coulomb repulsion and does not need to be uniform. Moreover, in addition to atomic Ytterbium ions, neutral atoms, Rydberg atoms, different atomic ions or different species of atomic ions may also be used. The trap may be a linear RF Paul trap, but other types of confinement may also be used, including optical confinements. Thus, a confinement device may be based on different techniques and may hold ions, neutral atoms, or Rydberg atoms, for example, with an ion trap being one example of such a confinement device. The ion trap may be a surface trap, for example.

FIG. 2 shown below is a block diagram that illustrates an example of a QIP system 200 in accordance with various aspects of this disclosure. The QIP system 200 may also be referred to as a quantum computing system, a quantum computer, a computer device, a trapped ion system, or the like. The QIP system 200 may be part of a hybrid computing system in which the QIP system 200 is used to perform quantum computations and operations and the hybrid computing system also includes a classical computer to perform classical computations and operations.

Shown in FIG. 2 is a general controller 205 configured to perform various control operations of the QIP system 200. Instructions for the control operations may be stored in memory (not shown) in the general controller 205 and may be updated over time through a communications interface (not shown). Although the general controller 205 is shown separate from the QIP system 200, the general controller 205 may be integrated with or be part of the QIP system 200. The general controller 205 may include an automation and calibration controller 280 configured to perform various calibration, testing, and automation operations associated with the QIP system 200.

In an aspect, general controller 205 is configured to implement quantum process estimation functions of the quantum process estimation system 289 as described herein. In an aspect, the general controller 205 represents the controller of the quantum process estimation system. In another aspect, a separate controller can be used to control the other components of the quantum process estimation system 289.

The QIP system 200 may include an algorithms component 210 that may operate with other parts of the QIP system 200 to perform quantum algorithms or quantum operations, including a stack or sequence of combinations of single qubit operations and/or multi-qubit operations (e.g., two-qubit operations) as well as extended quantum computations. As such, the algorithms component 210 may provide instructions to various components of the QIP system 200 (e.g., to the optical and trap controller 220) to enable the implementation of the quantum algorithms or quantum operations. The algorithms component 210 may receive information resulting from the implementation of the quantum algorithms or quantum operations and may process the information and/or transfer the information to another component of the QIP system 200 or to another device for further processing.

The QIP system 200 may include an optical and trap controller 220 that controls various aspects of a trap 270 in a chamber 250, including the generation of signals to control the trap 270, and controls the operation of a laser(s) and optical systems that provide optical beams that interact with the atoms or ions in the trap. When used to confine or trap ions, the trap 270 may be referred to as an ion trap. The trap 270, however, may also be used to trap neutral atoms, Rydberg atoms, different atomic ions or different species of atomic ions. The laser(s) and optical systems can be at least partially located in the optical and trap controller 220 and/or in the chamber 250. For example, optical systems within the chamber 250 may refer to optical components or optical assemblies.

The optical and trap controller 220 may be controlled by general controller 205 or a dedicated quantum process estimation controller (not shown) to alter the laser characteristics in order to change the parameters of the MS gate applied to 2 qubits being evaluated at any given time. Aspects of the disclosure provide a feedback mechanism that uses estimates of quantum process imperfections in the quantum MS gate generated by circuits configured to estimate a quantum process applied to a MS gate to alter MS gate parameters and reduce and/or otherwise eliminate MS gate imperfections. To achieve the proceeding, the general controller 205 or dedicated quantum process estimation controller (not shown) will interface with at least the optical and trap controller 220 and optionally the algorithms components 210 and the laser and imaging system 230 described hereinafter. The algorithms components 210 may be configured to store programs relating to quantum process estimation including circuit families as described herein that may be run on the QIP system 200 to determine and then correct quantum process imperfections relating to a MS gate. The laser and imaging system 230 may be used to confirm quantum process estimates provided by various aspects of the present disclosure.

Thus, the QIP system 200 may include, or may interface with, at least some components of a quantum process estimation system 289. In the aspect of FIG. 2, the general controller 205, the laser and imaging system 230 and the optical and trap controller 220, and the algorithms component 210 may be used by the quantum process estimation system 289 to cooperatively estimate a quantum process.

As noted above, the QIP system 200 may include a laser and imaging system 230. The laser and imaging system 230 may include a high-resolution imager (e.g., CCD camera) or other type of detection device (e.g., photomultiplier tube or PMT) for monitoring the atomic ions while they are being provided to the trap 270 and/or after they have been provided to the trap 270. In an aspect, the laser and imaging system 230 can be implemented separate from the optical and trap controller 220, however, the use of fluorescence to detect, identify, and label atomic ions using image processing algorithms may need to be coordinated with the optical and trap controller 220.

In addition to the components described above, the QIP system 200 can include a source 260 that provides atomic species (e.g., a plume or flux of neutral atoms) to the chamber 250 having the trap 270. When atomic ions are the basis of the quantum operations, that trap 270 confines the atomic species once ionized (e.g., photoionized). The trap 270 may be part of a processor or processing portion of the QIP system 200. That is, the trap 270 may be considered at the core of the processing operations of the QIP system 200 since it holds the atomic-based qubits that are used to perform the quantum operations or simulations. At least a portion of the source 260 may be implemented separate from the chamber 250.

It is to be understood that the various components of the QIP system 200 described in FIG. 2 are described at a high-level for ease of understanding. Such components may include one or more sub-components, the details of which may be provided below as needed to better understand certain aspects of this disclosure.

Aspects of this disclosure may be implemented at least partially using the general controller 205, the automation and calibration controller 280, and/or the algorithms component 210.

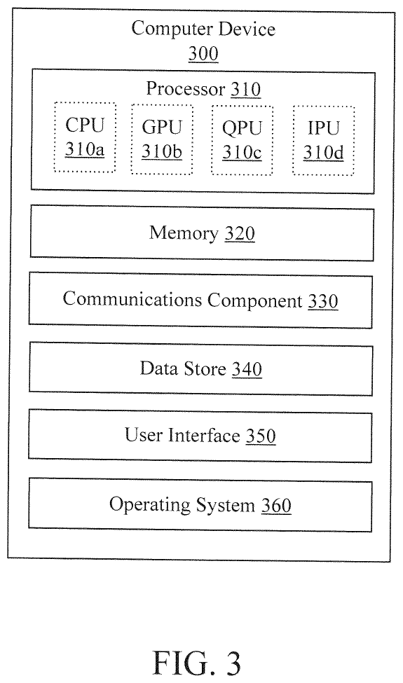

Referring now to FIG. 3 shown below, illustrated is an example of a computer system or device 300 in accordance with aspects of the disclosure. The computer device 300 can represent a single computing device, multiple computing devices, or a distributed computing system, for example. The computer device 300 may be configured as a quantum computer (e.g., a QIP system), a classical computer, or to perform a combination of quantum and classical computing functions, sometimes referred to as hybrid functions or operations. For example, the computer device 300 may be used to process information using quantum algorithms, classical computer data processing operations, or a combination of both. In some instances, results from one set of operations (e.g., quantum algorithms) are shared with another set of operations (e.g., classical computer data processing). A generic example of the computer device 300 implemented as a QIP system capable of performing quantum computations and simulations is, for example, the QIP system 200 shown in FIG. 2.

The computer device 300 may include a processor 310 for carrying out processing functions associated with one or more of the features described herein. The processor 310 may include a single or multiple set of processors or multi-core processors. Moreover, the processor 310 may be implemented as an integrated processing system and/or a distributed processing system. The processor 310 may include one or more central processing units (CPUs) 310a, one or more graphics processing units (GPUs) 310b, one or more quantum processing units (QPUs) 310c, one or more intelligence processing units (IPUs) 310d (e.g., artificial intelligence or AI processors), or a combination of some or all those types of processors. In one aspect, the processor 310 may refer to a general processor of the computer device 300, which may also include additional processors 310 to perform more specific functions (e.g., including functions to control the operation of the computer device 300).

The computer device 300 may include a memory 320 for storing instructions executable by the processor 310 to carry out operations. The memory 320 may also store data for processing by the processor 310 and/or data resulting from processing by the processor 310. In an implementation, for example, the memory 320 may correspond to a computer-readable storage medium that stores code or instructions to perform one or more functions or operations. Just like the processor 310, the memory 320 may refer to a general memory of the computer device 300, which may also include additional memories 320 to store instructions and/or data for more specific functions.

It is to be understood that the processor 310 and the memory 320 may be used in connection with different operations including but not limited to computations, calculations, simulations, controls, calibrations, system management, and other operations of the computer device 300, including any methods or processes described herein.

Further, the computer device 300 may include a communications component 330 that provides for establishing and maintaining communications with one or more parties utilizing hardware, software, and services. The communications component 330 may also be used to carry communications between components on the computer device 300, as well as between the computer device 300 and external devices, such as devices located across a communications network and/or devices serially or locally connected to computer device 300. For example, the communications component 330 may include one or more buses, and may further include transmit chain components and receive chain components associated with a transmitter and receiver, respectively, operable for interfacing with external devices. The communications component 330 may be used to receive updated information for the operation or functionality of the computer device 300.

Additionally, the computer device 300 may include a data store 340, which can be any suitable combination of hardware and/or software, which provides for mass storage of information, databases, and programs employed in connection with the operation of the computer device 300 and/or any methods or processes described herein. For example, the data store 340 may be a data repository for operating system 360 (e.g., classical OS, or quantum OS, or both). In one implementation, the data store 340 may include the memory 320. In an implementation, the processor 310 may execute the operating system 360 and/or applications or programs, and the memory 320 or the data store 340 may store them.

The computer device 300 may also include a user interface component 350 configured to receive inputs from a user of the computer device 300 and further configured to generate outputs for presentation to the user or to provide to a different system (directly or indirectly). The user interface component 350 may include one or more input devices, including but not limited to a keyboard, a number pad, a mouse, a touch-sensitive display, a digitizer, a navigation key, a function key, a microphone, a voice recognition component, any other mechanism capable of receiving an input from a user, or any combination thereof. Further, the user interface component 350 may include one or more output devices, including but not limited to a display, a speaker, a haptic feedback mechanism, a printer, any other mechanism capable of presenting an output to a user, or any combination thereof. In an implementation, the user interface component 350 may transmit and/or receive messages corresponding to the operation of the operating system 360. When the computer device 300 is implemented as part of a cloud-based infrastructure solution, the user interface component 350 may be used to allow a user of the cloud-based infrastructure solution to remotely interact with the computer device 300.

Referring to FIG. 4, an exemplary overview 400 of MS Tomography is shown in accordance with various exemplary aspects.

The overview 400 includes a MS Tomography core components portion (hereinafter “core components portion”) 410 and a workflow portion 450.

The core components portion 410 includes data that is stored in a memory device accessible by the controller 205 in order to control the QIP system 200 by applying the workflow portion 450 to the data. The QIP system 200 may be controlled, for example, by controlling various components of the QIP system such as the algorithms component 210 and the laser and imaging system, by the controller 205.

The algorithms component 210 and/or a memory associated with the algorithms component 210 may store the workflow portion 450, and may further store method 600 and method 900 described in further detail hereinbelow.

The workflow portion 450 corresponds to the core components 410A of the core component portion 410 being applied to obtain MS tomography parameters 459.

The core components 410A includes the “definition of circuit families” 411, the “definition of how to process circuit outcome histograms for each family” 412, and a “matrix relating slopes to parameter estimates” 413. The definition of circuit families 411 is applied to a list of circuits 451 that are run 452 on a quantum computer (QC) such as QIP system 200. In an aspect, controller 205 of QIP system 200 performs the workflow portion 450 of FIG. 4, as well as executes the example circuit 500 of FIG. 5. The definition of how to process circuit outcome histograms for each family 412 is applied to histogram data 453 to process 454 the histogram data into processed histogram data 455 from which lines slopes 457 are extracted 456. A simple linear fit may be used or more complex fitting techniques such as maximizing the likelihood between an MS-gate noise model and the data. A matrix relating slopes to parameter estimates 413 is applied to line slopes 457 using linear algebra 458 to obtain the MS tomography parameters 459.

The MS tomography parameters 459 may then be acted upon by the controller 205 of the QIP system 200 to cause the laser and imaging system 230 to apply and/or otherwise alter laser characteristics that control qubit position and other qubit parameters to calibrate a MS gate of the QIP system 200 to minimize or eliminate the measured error in the MS gate. Types of errors with respect to different ones of the circuit families are described below. For example, any of (1) over-rotation or under-rotation, (2) spin-phase offsets, and (3) light-shifts, may be detected in the QIP system 200 and corrected in the QIP system 200 to optimize MS gate performance, where optimize means to reduce or eliminate one or more errors in MS gate performance.

Referring to FIG. 5, an example circuit 500 of a circuit family is shown, in accordance with an example aspect.

Circuit 500 includes a core sub-circuit 502 bookended by a preparation sub-circuit 501 and a measure sub-circuit 503. The preparation sub-circuit 501 is a circuit configured to prepare the QIP system 200 to measure an error using the measure sub-circuit 503 after application of an error determining program by core sub-circuit 502. Core sub-circuit 502 may be repeated different numbers of times in order to provide different error detecting circuits within a same family, where the different error detecting circuits include the same preparation and measurement portions (sub-circuits) but differ in the number of repetitions of the core sub-circuit. The core sub-circuit 501 for a given family detects a particular type of error as described hereinbelow. The preparation sub-circuit 501 may provide initial values and may even involve controlling the laser and imaging system 230 to prepare the laser and imaging system 230 to apply the core sub-circuit 502 to 2 qubits of the QIP system 200 at a time in order to determine an error that is measured by the measure sub-circuit 503. The error may then be corrected or eliminated by the laser and imaging system 230 under the control of controller 205.

In an aspect, a circuit is embodied as a quantum program involving a preparation portion embodied by the preparation sub-circuit and a measure portion embodied by the measure sub-circuit. The sub-circuits are configured to estimate errors or imperfections in a quantum process.

In an aspect, a circuit family is a group of circuits having the same preparation sub-circuit, core sub-circuit, and measure sub-circuit, but differ in how many repetitions of the sub-circuit are performed in order to form a given circuit. In an aspect, a circuit family includes 4 circuits. In an aspect, the 4 circuits have the same preparation sub-circuit, core sub-circuit, and measure sub-circuit, but differ in how many times the core sub-circuit is repeated in order to form a given circuit. For example, a 1^{st} circuit may include a single repetition of the core sub-circuit, bookended by the preparation sub-circuit and measure sub-circuit, a 2^{nd} circuit may include two repetitions of the core sub-circuit, bookended by the preparation sub-circuit and measure sub-circuit, a 3^{rd} circuit may include three repetitions of the core sub-circuit, bookended by the preparation sub-circuit and measure sub-circuit, and a 4th circuit may include four repetitions of the core sub-circuit, bookended by the preparation sub-circuit and measure sub-circuit. As another example, a 1^{st} circuit may include a single repetition of the core sub-circuit, bookended by the preparation sub-circuit and measure sub-circuit, a 2nd circuit may include two repetitions of the core sub-circuit, bookended by the preparation sub-circuit and measure sub-circuit, a 3^{rd} circuit may include four repetitions of the core sub-circuit, bookended by the preparation sub-circuit and measure sub-circuit, and a 4^{th} circuit may include eight repetitions of the core sub-circuit, bookended by the preparation sub-circuit and measure sub-circuit. This scenario is shown in FIG. 12 (in having 4 points per line, with one point per circuit). In other aspects, other (different) numbers of repetitions in at least some of the 1 through 4 circuits may be performed than those described above and shown in FIG. 12.

Referring now to FIGS. 6-9, a quantum process estimation method 600 for a QIP system is shown and described in accordance with various exemplary aspects. In an aspect, the quantum process estimation method 600 can be at least primarily performed by the general controller 205. In an aspect, blocks 610 through 620 may be performed by general controller 205.

Referring to FIGS. 4-9, at block 610, the method 600 includes obtaining estimates of quantum process imperfections in a quantum Mølmer-Sørensen gate 453 by running on a quantum computer (QC) a plurality of circuit families configured to evaluate the quantum process. Each of the circuit families in the plurality of circuit families includes a number of circuits 500. Each of the circuits 500 includes a core sub-circuit 502 bookended by a preparation sub-circuit 501 and a measure sub-circuit 503. Each of the circuits 500 in a respective one of the circuit families differs from other circuits in that family based on including a different number of repetitions of the core sub-circuit 502. In an aspect, the quantum process imperfections in the quantum process applied to the MS gate arise from at least one of over-rotation, under-rotation, spin-phase offset, and light-shift. The estimates of quantum process imperfections in a quantum Mølmer-Sørensen gate may be multi-dimensional and corresponding to two or more error types.

In an aspect, block 610 may include one or more blocks 610A through 610G.

At block 610A, the method 600 includes repeating the core sub-circuit 502 X number of times (as shown by the loop 504 in FIG. 5), wherein X is an integer. In an aspect X≤ to 4. Of course, other values for X can also be used.

At block 610B, the method 600 includes forming the circuits for a same one of the families by changing an amount of looping that is performed over the core sub-circuit 502 from circuit-to-circuit.

At block 610C, the method 600 includes running at least two of the plurality of circuit families in parallel.

At block 610D, the method 600 includes configuring the estimates of quantum process imperfections in the quantum MS gate to be sensitive to different linear combinations of different error types causing the quantum process imperfections.

At block 610E, the method 600 includes receiving the estimates of quantum process imperfections in the quantum MS gate within a feedback and control loop configured to automatically tune the quantum gates to reduce their imperfections.

At block 610F, the method 600 includes calculating a histogram 453 for each run of a respective one of the 5 circuit families.

At block 610G, the method 600 includes calculating slopes 457 of multiple lines representing multiple linear combinations of circuit outcome frequencies for each run of the 5 circuit families.

In an aspect, block 610G may include one or more of blocks 610G1 and 610G2.

At block 610G1, the method 600 includes forming matrices 413 relating the slopes to MS gate parameter estimates 459.

At block 610G2, the method 600 includes mapping the slopes 457 to MS gate parameters 459.

At block 610H, the method 600 includes applying the circuits 500 of the respective one of the plurality of circuit families to 2 qubits to obtain the estimates of quantum process imperfections in a quantum Mølmer-Sørensen gate including a corresponding one of 4 different possible circuit outcomes for the 2 qubits with a respective occurrence percentage assigned to each of the 4 different circuit possible outcomes that add up to 100 percent. In an aspect, the estimates of quantum process imperfections in a quantum Mølmer-Sørensen gate include X sets of probabilities. X is an integer equal to a number of circuit families used times a number of the circuits included in the plurality of circuit families. The number of circuit families used is equal to 5 in the illustrative aspects described herein. However, other numbers of circuit families can be used given the teachings of the instant disclosure provided herein.

In an aspect, block 610H may include block 610H1.

At block 610H1, the method 600 includes combining the X sets of probabilities using various different algebraic methods.

At block 610I, the method 600 includes configuring each of different repetitions of the core sub-circuit 502 of each the plurality of circuit families to correspond to different circuit depths based on different core sub-circuit repetition run times.

At block 610J, the method 600 includes generating a plot having an axis representing different circuit depths and another axis representing linear combinations of circuit outcome probabilities.

In an aspect, block 610J may include block 610J1.

At block 610J1, the method 600 includes fitting a respective one of multiple plot lines to multiple linear combinations of circuit outcome probabilities for a respective one of the plurality of circuit families. In an aspect, each of the multiple plot lines includes a respective point for each circuit 500 of a respective one of the plurality of circuit families.

In an aspect, block 610J1 may include 610J1A.

At block 610J1A, the method 600 includes determing a type and a degree of a respective error of the MS gate from a slope of each of the multiple plot lines.

In an aspect, block 610J1 may include block 610J1A1.

At block 610J1A1, the method 600 includes determining the degree of the respective error of the MS gate in a manner non-overlapping with other error types.

At block 610K, the method 600 includes calculating line data, to form lines of a plot, from estimates of quantum process imperfections in a quantum Mølmer-Sørensen gate of the circuits 500 of the plurality of circuit families, and determining a degree of error and a type of error of the quantum process imperfections from respective slopes 457 of the lines of the plot. In an aspect, the type of error and the degree of error are determined to be independently correctable by controlling certain MS gate parameters 459 specific to the type of error and the degree or error.

At block 620, the method 600 includes calibrating the MS gate responsive to the estimates of quantum process imperfections in a quantum Mølmer-Sørensen gate to reduce the quantum process imperfections.

In an aspect, block 620 may include one or more of blocks 620A and 620B.

At block 620A, the method 600 includes controlling one or more lasers 230 to reduce the quantum process imperfections.

At block 620B, the method includes controlling the degree of the respective error of the MS gate in a manner non-overlapping with other error types.

At block 630, the method 600 includes performing a recalibration by repeating block 610 through block 620 using dynamic qubit data feedback. That is, qubit data is newly recaptured at predetermined or random times under the control of the general controller 205 in order to sense noise and/or other errors and react to the noise, i.e., cancel the noise and/or other errors. The general controller 205 and the laser and imaging system 230 of the optical and trap controller 220 as well as the algorithms component 210 may be used by the quantum process estimation system 289 to cooperatively capture new qubit data periodically or randomly and adjust the MS gate parameters accordingly in a dynamic feedback based manner. In this way, imperfections in a quantum state may be estimated by the quantum process estimating system 289 using a feedback loop formed from the recapture of the qubit data.

Referring to FIG. 10, example definitions of 5 circuit families are shown, in accordance with example aspects of this disclosure. The definition

Each circuit family definition 1001 is designated by an integer from, e.g., 0 to 4, and includes a prefix (or preparation sub-circuit) 1002, a core (or core sub-circuit) 1003, and a postfix (or measure sub-circuit) 1004. In an aspect, prefix 1002 corresponds to preparation sub-circuit 501 of FIG. 5, core 1003 corresponds to core sub-circuit 502 of FIG. 5, and postfix 1004 corresponds to measure sub-circuit 503 of FIG. 5.

In the aspect of FIG. 10, the following prefix descriptions apply: Y_{π/2}⁽ⁱ⁾ is a y-axis rotation gate on qubit i of π/2 radians.

In the aspect of FIG. 10, the following postfix descriptions apply: X_{π/2}⁽ⁱ⁾ is an x-axis rotation gate on qubit i of π/2 radians and Y_{π/2}⁽ⁱ⁾ is a y-axis rotation gate on qubit i of π/2 radians.

In the aspect of FIG. 10, the following family descriptions apply: Y_{π/2}⁽ⁱ⁾ is a y-axis rotation gate on qubit i of π/2 radians and MS is a Mølmer-Sørensen gate.

Family 0 is configured to detect systematic light-shift and spin-phase errors on the first qubit, as well as stochastic over-rotation and spin-phase errors on the first qubit.

Family 1 is configured to detect systematic light-shift and spin-phase errors on the second qubit, as well as stochastic over-rotation and spin-phase errors on the second qubit.

Family 2 is configured to detect systematic over-rotation errors.

Family 3 is configured to detect systematic light-shift errors on the second qubit, as well as stochastic over-rotation and spin-phase errors.

Family 4 is configured to detect systematic light-shift errors on the first qubit, as well as stochastic over-rotation and spin-phase errors.

For each family definition 1001, a number of repetitions (not shown in FIG. 10, but shown in FIG. 5) of the core is performed, while the bookended prefix 1002 and postfix 1004 are performed once per run of a given family. Each family includes a number of circuits. Each circuit differs in the number of repetitions (loops) of the core 1003 that are performed from circuit-to-circuit. The number of repetitions of the core 1003 is adjustable. In a preferred embodiment, 4 circuits per family are formed from 4 different sets of repetitions of the core 1003 bookended by the prefix 1002 and postfix 1004, resulting in a total of 20 circuits. However, other numbers of circuits per family may be used.

Referring to FIG. 11, example methods for processing circuit outcome histograms for each family are shown, in accordance with example aspects of this disclosure.

Each circuit family definition 1001 is designated by an integer from, e.g., 0 to 4 (with each integer representing a respective family), and includes an index 1102 and a method 1103 for combining outcome counts (P-values) to get “processed values”. A P-value is a probability of a given circuit outcome (a probability of obtaining one of (0,0)(0,1)(1,0)(1,1)) as explained above. An index 1102 indexes a method 1103, and is a value representing one method of X possible methods 1103 that can be used to combine probabilities values. Here, two methods 1103 are used for each of families 0, 1, 3, and 4, and one method 1103 is used for family 2. The two methods 1103 are indexed by index 0 and index 1 and the one method is index by index 0.

Thus, in the aspect of FIG. 11, each family 0, 1, 3, and 4 is processed two times, and family 2 is processed once, although other numbers can be used. In a preferred embodiment of FIG. 11, there are 20 circuits (5 families and 4 circuits per family), with 9 different methods 1103 to process each circuit corresponding to each (family, index) pair.

However, other possibilities exist, such as combining results across circuits such that different circuit families are processed different numbers of times. In this way, a single family such as family 2 as shown in FIG. 1 may nonetheless produce up to 4 processed values (up to one for each P value).

In the aspect of FIG. 11, the processed value for family 0, index 0 is determined as P₁₁-P₀₁, or the P value or probability Pu minus the P value or probability P₀₁. In further detail, the P-value P₁₁ represents the probability of an outcome of (1,1) for a circuit for family 0, and the P-value P₀₁ represents the probability of an outcome of (0,1) for a circuit for family 0. “[A] circuit for family 0” may be the same circuit in family 0 or may be two or more different circuits in family 0.

In contrast, in the aspect of FIG. 11, the processed value for family 0, index 1 is P₀₀+P₁₀−P₀₁−P₁₁, or the sum of P value or probability P₀₀ with P value or probability P₁₀ minus a difference between P value or probability P₀₁ and P value or probability Pn. In further detail: the P-value P₀₀ represents the probability of an outcome of (0,0) for a circuit for family 0; the P-value P₀₁ represents the probability of an outcome of (0,1) for a circuit for family 0; the P-value P₀₁ represents the probability of an outcome of (0,1) for a circuit for family 0; and the P-value Pu represents the probability of an outcome of (1,1) for a circuit for family 0. “[A] circuit for family 0” may be the same circuit in family 0 or may be two or more different circuits in family 0.

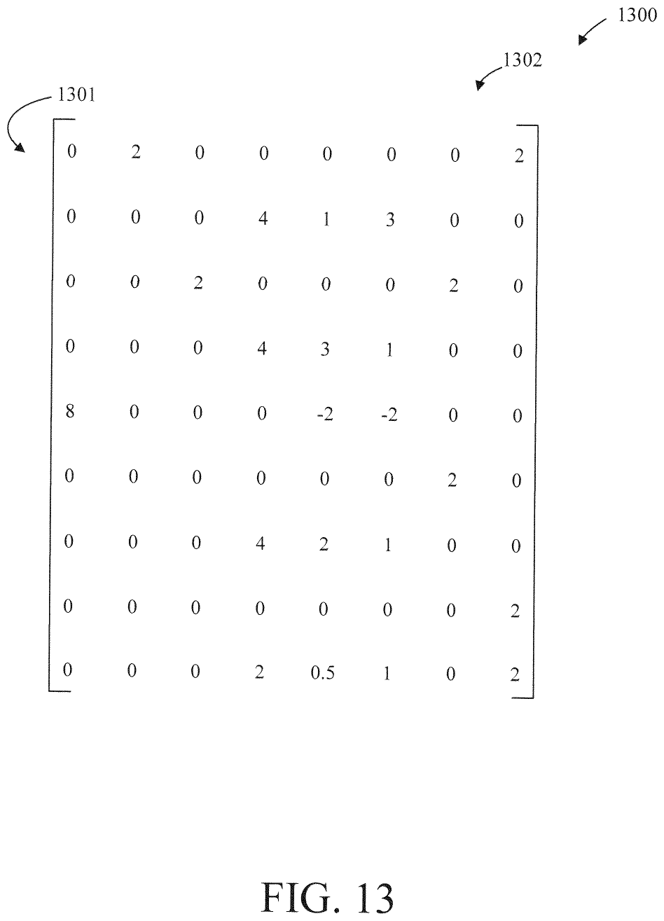

As noted above, in an aspect, these outcomes of (0,0), (0,10), (1,0), and (1,1) correspond to four possible outcomes (states) of two qubits subject to a given circuit (see, e.g., FIG. 5) with associated probabilities of those outcomes occurring such that the sum of the probabilities of the four outcomes is equal to one. Adding and/or subtracting these probabilities can be as shown in FIG. 11 or in any other manner (that is, any other sequences of addition and/or subtraction) to arrive at values within a range such as, for example, between, −1.0 and 1.0 as shown in FIG. 12 and FIG. 13 or some other range. For example, these values may correspond to the points in the lines in the plot of FIG. 12, that is, the y-axis. Thus, as noted, each circuit family may provide one or more, and preferably at least four circuit outcomes that are independent in the type of error and independent in the MS gate parameters that need to be controlled to correct the type (and degree) of error.

Referring to FIGS. 12-14, an example of processed data is shown, in accordance with example aspects of this disclosure.

In FIG. 12, an example plot 1200 is shown relating to processing circuit outcome histograms for each family in accordance with teachings of various aspects of the present disclosure. The X axis denotes circuit depth, i.e., the number of repetitions of the core 1003. The Y axis denotes processed values, that is, circuit outcomes derived from applying algebraic functions 1103 to the probabilities assigned to a given circuit outcome (of, e.g., 00, 01, 10, and 11, for 2 qubits being contemporaneously evaluated). The X axis ranges from −0.2 to 0.6 and the Y axis ranges from 1 to 8 in the aspect of FIG. 12. Each Y axis value represents a value obtained by combining probabilities as shown in FIG. 11 and corresponds to processed circuit outcomes histogram values. Each X axis value represents a number of repetition of the core 1003 of a circuit.

In FIG. 12, there is 2 lines (families 0, 1, 3, and 4) or 1 line (family 2) per family depending upon how many ways (as represented by the different indices 0 and 1) are used to combine the probabilities corresponding to the circuit outcomes as shown in FIG. 11.

In FIG. 12, there are 4 points per line, corresponding to 4 circuit per family, where as noted above, circuits in a family simply differ in the number of repetitions of the core 1003.

Referring to FIG. 13, an example matrix 1300 relating line slopes to parameter estimates is shown, in accordance with example aspects of this disclosure.

The matrix 1300 has 9 rows 1301 corresponding to slopes of lines (of, e.g., FIG. 12). The matrix 1300 also has 8 columns 1302 corresponding to 8 separate MS gate parameters. The MS gate parameters are separate in that control of one parameter does not affect control of any other parameters. The values of the line slopes of the various circuits indicate a type and a degree of a particular type of various types of errors.

The MS gate parameters include systematic over-rotation errors, systematic spin-phase and light shift errors on each qubit (4 values in total), stochastic over-rotation errors, and stochastic spin-phase errors on each qubit.

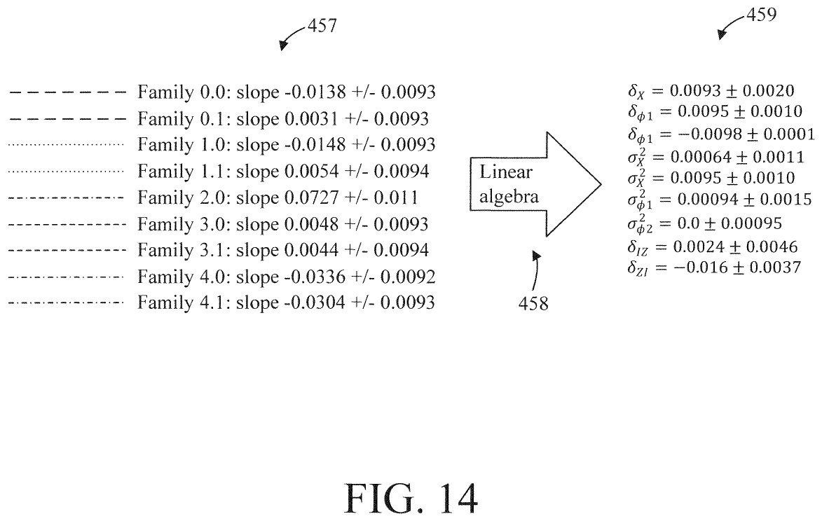

Referring to FIG. 14, line slopes 457 for circuits for each family (e.g., for index 0 and index 1 of families 0, 1, 3, and 4, and for index 0 of family 2) are shown.

The slope for family 0, index 0, denoted family 0.0, is −0.0138+−0.0093. A slope m of a line segment is determined as follows: slope m=(y₂−y₁)/(x₂−x₁). The slope represents the change in rise over the change in run (change in y values over the change in x values). A best-fit line is computed for each set of 4 points using standard linear regression techniques such as linear least-squares minimization. This gives a slope and error bar 457 show in FIG. 14. Other approaches can be used, such as weighting the points differently or by maximizing the likelihood between a model for the noisy MS gate and the data.

The linear relationship between the slopes and MS gate parameters allows the use of linear algebra 458 (multiplication of the slopes 457 by the inverse of matrix 1300) to obtain MS gate parameters 459.

Examples of MS gate parameters 459 can include, for example, systematic over-rotation errors, systematic spin-phase and light shift errors on either qubit, stochastic over-rotation errors, and stochastic spin-phase errors on either qubit.

As an example regarding applying linear algebra 458 to the slopes 457, parameter 459 δ_{X}=0.0093±0.0020 is determined by multiplying a vector of line slopes corresponding to family 0, index 0, by the first row of the inverse of matrix 1300, which (before inversion) maps gate parameters to line slopes. As a further example regarding applying linear algebra 458 to the slopes 457, parameter 459 δ_{X}=0.0095±0.0010 is determined by multiplying a vector of line slopes corresponding to family 0, index 1, by the second row of the inverse of matrix 1300.

Clause 1. A computer-implemented method, comprising: obtaining estimates of quantum process imperfections in a quantum Mølmer-Sørensen (MS) gate by running on a quantum computer (QC) a plurality of circuit families configured to evaluate the quantum process, wherein each of the circuit families comprises a number of circuits that each comprise a core sub-circuit for determining a particular type of quantum process imperfection bookended by a preparation sub-circuit and a measure sub-circuit, wherein each of the circuits in a respective one of the circuit families differs from other circuits in that family based on including a different number of repetitions of the core sub-circuit; and calibrating the quantum process responsive to the estimates of quantum process imperfections in the quantum MS gate to reduce the quantum process imperfections.

Clause 2. The computer-implemented method in accordance with clause 1, wherein the quantum process imperfections in the quantum MS gate arise from at least one of over-rotation, under-rotation, spin-phase offset, and light-shift.

Clause 3. The computer-implemented method in accordance with any preceding clauses, further comprising repeating the core sub-circuit X number of times, wherein X is an integer.

Clause 4. The computer-implemented method in accordance with any preceding clauses, further comprising forming the circuits for a same one of the plurality of circuit families by changing an amount of looping that is performed over the core sub-circuit from circuit-to-circuit.

Clause 5. The computer-implemented method in accordance with any preceding clauses, wherein obtaining the estimates of quantum process imperfections in the quantum MS gate comprises running at least two of the plurality of circuit families in parallel.

Clause 6. The computer-implemented method in accordance with any preceding clauses, further comprising configuring the estimates of quantum process imperfections in the quantum MS gate to be sensitive to different linear combinations of different error types causing the quantum process imperfections.

Clause 7. The computer-implemented method in accordance with any preceding clauses, wherein the error types causing the quantum process imperfections comprise at least one of over-rotation, under-rotation, spin-phase offset, and light-shift.

Clause 8. The computer-implemented method in accordance with any preceding clauses, wherein the estimates of quantum process imperfections in the quantum MS gate are multi-dimensional, corresponding to at least two different error types.

Clause 9. The computer-implemented method in accordance with any preceding clauses, further comprising receiving the estimates of quantum process imperfections in the quantum MS gate within a feedback and control loop configured to automatically tune the quantum gates to reduce their imperfections.

Clause 10. The computer-implemented method in accordance with any preceding clauses, wherein calibrating the MS gate responsive to the estimates of quantum process imperfections in the quantum MS gate comprises controlling one or more lasers to reduce the quantum process imperfections.

Clause 11. The computer-implemented method in accordance with any preceding clauses, wherein obtaining estimates of quantum process imperfections in the quantum MS gate comprises calculating a histogram for each run of a respective one of the circuit families.

Clause 12. The computer-implemented method in accordance with any preceding clauses, wherein obtaining estimates of quantum process imperfections in the quantum MS gate comprises calculating slopes of multiple lines representing multiple linear combinations of circuit outcome frequencies for each run of the circuit families.

Clause 13. The computer-implemented method in accordance with any preceding clauses, wherein obtaining estimates of quantum process imperfections in the quantum MS gate further comprises forming at least one matrix relating the slopes to MS gate parameter estimates.

Clause 14. The computer-implemented method in accordance with any preceding clauses, wherein obtaining estimates of quantum process imperfections in the quantum MS gate further comprising mapping the slopes to MS gate parameters.

Clause 15. The computer-implemented method in accordance with any preceding clauses, wherein running a respective one of the plurality of circuit families comprises applying the circuits of the respective one of the plurality of circuit families to 2 qubits to obtain the estimates of quantum process imperfections in the quantum MS gate comprising a corresponding one of different possible circuit outcomes for the 2 qubits with a respective occurrence percentage assigned to each of the different circuit possible outcomes that add up to 100 percent.

Clause 16. The computer-implemented method in accordance with any preceding clauses, wherein the estimates of quantum process imperfections in the quantum MS gate comprise X sets of probabilities, where X is an integer equal to a number of circuit families used times a number of the circuits comprised in the plurality of circuit families.

Clause 17. The computer-implemented method in accordance with any preceding clauses, wherein obtaining the estimates of quantum process imperfections in the quantum MS gate comprises combining the X sets of probabilities using various different algebraic methods.

Clause 18. The computer-implemented method in accordance with any preceding clauses, further comprising configuring each of different repetitions of the core sub-circuit of each the plurality of circuit families to correspond to different circuit depths based on different core sub-circuit repetition run times.

Clause 19. The computer-implemented method in accordance with any preceding clauses, further comprising generating a plot having an axis representing different circuit depths and another axis representing linear combinations of circuit outcome probabilities.

Clause 20. The computer-implemented method in accordance with any preceding clauses, wherein generating a plot comprises fitting a respective one of multiple plot lines to multiple linear combinations of circuit outcome probabilities for a respective one of the plurality of circuit families.

Clause 21. The computer-implemented method in accordance with any preceding clauses, wherein each of the multiple plot lines comprises a respective point for each circuit of a respective one of the circuit families.

Clause 22. The computer-implemented method in accordance with any preceding clauses, further comprising determining a type and a degree of a respective error of the MS gate from a slope of each of the multiple plot lines.

Clause 23. The computer-implemented method in accordance with any preceding clauses, wherein a degree of a respective error of the MS gate is determined and controlled in a manner non-overlapping with other error types.

Clause 24. The computer-implemented method in accordance with any preceding clauses, further comprising: calculating line data, to form lines of a plot from the estimates of quantum process imperfections in the quantum MS gate; and determining a degree of error and a type of error of the quantum process imperfections from respective slopes of the lines of the plot.

Clause 25. The computer-implemented method in accordance with any preceding clauses, wherein the type of error and the degree of error are determined to be independently correct by controlling certain MS gate parameters specific to the type of error and the degree or error.

Various aspects of the disclosure may take the form of an entirely or partially hardware aspect, an entirely or partially software aspect, or a combination of software and hardware. Furthermore, as described herein, various aspects of the disclosure (e.g., systems and methods) may take the form of a computer program product comprising a computer-readable non-transitory storage medium having computer-accessible instructions (e.g., computer-readable and/or computer-executable instructions) such as computer software, encoded or otherwise embodied in such storage medium. Those instructions can be read or otherwise accessed and executed by one or more processors to perform or permit the performance of the operations described herein. The instructions can be provided in any suitable form, such as source code, compiled code, interpreted code, executable code, static code, dynamic code, assembler code, combinations of the foregoing, and the like. Any suitable computer-readable non-transitory storage medium may be utilized to form the computer program product. For instance, the computer-readable medium may include any tangible non-transitory medium for storing information in a form readable or otherwise accessible by one or more computers or processor(s) functionally coupled thereto. Non-transitory storage media can include read-only memory (ROM); random access memory (RAM); magnetic disk storage media; optical storage media; flash memory, and so forth.

Aspects of this disclosure are described herein with reference to block diagrams and flowchart illustrations of methods, systems, apparatuses, and computer program products. It can be understood that each block of the block diagrams and flowchart illustrations, and combinations of blocks in the block diagrams and flowchart illustrations, respectively, can be implemented by computer-accessible instructions. In certain implementations, the computer-accessible instructions may be loaded or otherwise incorporated into a general-purpose computer, a special-purpose computer, or another programmable information processing apparatus to produce a particular machine, such that the operations or functions specified in the flowchart block or blocks can be implemented in response to execution at the computer or processing apparatus.

Unless otherwise expressly stated, it is in no way intended that any protocol, procedure, process, or method set forth herein be construed as requiring that its acts or steps be performed in a specific order. Accordingly, where a process or method claim does not actually recite an order to be followed by its acts or steps, or it is not otherwise specifically recited in the claims or descriptions of the subject disclosure that the steps are to be limited to a specific order, it is in no way intended that an order be inferred, in any respect. This holds for any possible non-express basis for interpretation, including: matters of logic with respect to the arrangement of steps or operational flow; plain meaning derived from grammatical organization or punctuation; the number or type of aspects described in the specification or annexed drawings; or the like.

As used in this disclosure, including the annexed drawings, the terms “component,” “module,” “system,” and the like are intended to refer to a computer-related entity or an entity related to an apparatus with one or more specific functionalities. The entity can be either hardware, a combination of hardware and software, software, or software in execution. One or more of such entities are also referred to as “functional elements.” As an example, a component can be a process running on a processor, a processor, an object, an executable, a thread of execution, a program, and/or a computer. For example, both an application running on a server or network controller, and the server or network controller can be a component. One or more components can reside within a process and/or thread of execution and a component can be localized on one computer and/or distributed between two or more computers. Also, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which parts can be controlled or otherwise operated by program code executed by a processor. As yet another example, a component can be an apparatus that provides specific functionality through electronic components without mechanical parts, the electronic components can include a processor to execute program code that provides, at least partially, the functionality of the electronic components. As still another example, interface(s) can include I/O components or Application Programming Interface (API) components. While the foregoing examples are directed to aspects of a component, the exemplified aspects or features also apply to a system, module, and similar.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in this specification and annexed drawings should be construed to mean “one or more” unless specified otherwise or clear from context to be directed to a singular form.

In addition, the terms “example” and “such as” are utilized herein to mean serving as an instance or illustration. Any aspect or design described herein as an “example” or referred to in connection with a “such as” clause is not necessarily to be construed as preferred or advantageous over other aspects or designs described herein. Rather, use of the terms “example” or “such as” is intended to present concepts in a concrete fashion. The terms “first,” “second,” “third,” and so forth, as used in the claims and description, unless otherwise clear by context, is for clarity only and does not necessarily indicate or imply any order in time or space.

The term “processor,” as utilized in this disclosure, can refer to any computing processing unit or device comprising processing circuitry that can operate on data and/or signaling. A computing processing unit or device can include, for example, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can include an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. In some cases, processors can exploit nano-scale architectures, such as molecular and quantum-dot based transistors, switches and gates, in order to optimize space usage or enhance performance of user equipment. A processor may also be implemented as a combination of computing processing units.

In addition, terms such as “store,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory. Moreover, a memory component can be removable or affixed to a functional element (e.g., device, server).

Simply as an illustration, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Various aspects described herein can be implemented as a method, apparatus, or article of manufacture using standard programming and/or engineering techniques. In addition, various of the aspects disclosed herein also can be implemented by means of program modules or other types of computer program instructions stored in a memory device and executed by a processor, or other combination of hardware and software, or hardware and firmware. Such program modules or computer program instructions can be loaded onto a general-purpose computer, a special-purpose computer, or another type of programmable data processing apparatus to produce a machine, such that the instructions which execute on the computer or other programmable data processing apparatus create a means for implementing the functionality of disclosed herein.

The term “article of manufacture” as used herein is intended to encompass a computer program accessible from any computer-readable device, carrier, or media. For example, computer readable media can include but are not limited to magnetic storage devices (e.g., hard drive disk, floppy disk, magnetic strips, or similar), optical discs (e.g., compact disc (CD), digital versatile disc (DVD), blu-ray disc (BD), or similar), smart cards, and flash memory devices (e.g., card, stick, key drive, or similar).

The detailed description set forth herein in connection with the annexed figures is intended as a description of various configurations or implementations and is not intended to represent the only configurations or implementations in which the concepts described herein may be practiced. The detailed description includes specific details for the purpose of providing a thorough understanding of various concepts. However, it will be apparent to those skilled in the art that these concepts may be practiced without these specific details or with variations of these specific details. In some instances, well-known components are shown in block diagram form, while some blocks may be representative of one or more well-known components.

The previous description of the disclosure is provided to enable a person skilled in the art to make or use the disclosure. Various modifications to the disclosure will be readily apparent to those skilled in the art, and the common principles defined herein may be applied to other variations without departing from the scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A computer-implemented method, comprising:
obtaining estimates of quantum process imperfections in a quantum Mølmer-Sørensen (MS) gate by running on a quantum computer (QC) a plurality of circuit families configured to evaluate the quantum process, wherein each of the circuit families comprises a number of circuits that each comprise a core sub-circuit for determining a particular type of quantum process imperfection bookended by a preparation sub-circuit and a measure sub-circuit, wherein each of the circuits in a respective one of the circuit families differs from other circuits in that family based on including a different number of repetitions of the core sub-circuit; and
calibrating the quantum process responsive to the estimates of quantum process imperfections in the quantum MS gate to reduce the quantum process imperfections.

2. The computer-implemented method in accordance with claim 1, wherein the quantum process imperfections in the quantum MS gate arise from at least one of over-rotation, under-rotation, spin-phase offset, and light-shift.

3. The computer-implemented method in accordance with claim 1, further comprising repeating the core sub-circuit X number of times, wherein X is an integer.

4. The computer-implemented method in accordance with claim 1, further comprising forming the circuits for a same one of the plurality of circuit families by changing an amount of looping that is performed over the core sub-circuit from circuit-to-circuit.

5. The computer-implemented method in accordance with claim 1, wherein obtaining the estimates of quantum process imperfections in the quantum MS gate comprises running at least two of the plurality of circuit families in parallel.

6. The computer-implemented method in accordance with claim 1, further comprising configuring the estimates of quantum process imperfections in the quantum MS gate to be sensitive to different linear combinations of different error types causing the quantum process imperfections.

7. The computer-implemented method in accordance with claim 6, wherein the error types causing the quantum process imperfections comprise at least one of over-rotation, under-rotation, spin-phase offset, and light-shift.

8. The computer-implemented method in accordance with claim 1, wherein the estimates of quantum process imperfections in the quantum MS gate are multi-dimensional, corresponding to at least two different error types.

9. The computer-implemented method in accordance with claim 1, further comprising receiving the estimates of quantum process imperfections in the quantum MS gate within a feedback and control loop configured to automatically tune the quantum gates to reduce their imperfections.

10. The computer-implemented method in accordance with claim 1, wherein calibrating the MS gate responsive to the estimates of quantum process imperfections in the quantum MS gate comprises controlling one or more lasers to reduce the quantum process imperfections.

11. The computer-implemented method in accordance with claim 1, wherein obtaining estimates of quantum process imperfections in the quantum MS gate comprises calculating a histogram for each run of a respective one of the circuit families.

12. The computer-implemented method in accordance with claim 1, wherein obtaining estimates of quantum process imperfections in the quantum MS gate comprises calculating slopes of multiple lines representing multiple linear combinations of circuit outcome frequencies for each run of the circuit families.

13. The computer-implemented method in accordance with claim 12, wherein obtaining estimates of quantum process imperfections in the quantum MS gate further comprises forming at least one matrix relating the slopes to MS gate parameter estimates.

14. The computer-implemented method in accordance with claim 12, wherein obtaining estimates of quantum process imperfections in the quantum MS gate further comprising mapping the slopes to MS gate parameters.

15. The computer-implemented method in accordance with claim 1, wherein running a respective one of the plurality of circuit families comprises applying the circuits of the respective one of the plurality of circuit families to 2 qubits to obtain the estimates of quantum process imperfections in the quantum MS gate comprising a corresponding one of different possible circuit outcomes for the 2 qubits with a respective occurrence percentage assigned to each of the different circuit possible outcomes that add up to 100 percent.

16. The computer-implemented method in accordance with claim 15, wherein the estimates of quantum process imperfections in the quantum MS gate comprise X sets of probabilities, where X is an integer equal to a number of circuit families used times a number of the circuits comprised in the plurality of circuit families.

17. The computer-implemented method in accordance with claim 16, wherein obtaining the estimates of quantum process imperfections in the quantum MS gate comprises combining the X sets of probabilities using various different algebraic methods.

18. The computer-implemented method in accordance with claim 1, further comprising configuring each of different repetitions of the core sub-circuit of each the plurality of circuit families to correspond to different circuit depths based on different core sub-circuit repetition run times.

19. The computer-implemented method in accordance with claim 1, further comprising generating a plot having an axis representing different circuit depths and another axis representing linear combinations of circuit outcome probabilities.

20. The computer-implemented method in accordance with claim 19, wherein generating a plot comprises fitting a respective one of multiple plot lines to multiple linear combinations of circuit outcome probabilities for a respective one of the plurality of circuit families.

21. The computer-implemented method in accordance with claim 20, wherein each of the multiple plot lines comprises a respective point for each circuit of a respective one of the circuit families.

22. The computer-implemented method in accordance with claim 20, further comprising determining a type and a degree of a respective error of the MS gate from a slope of each of the multiple plot lines.

23. The computer-implemented method in accordance with claim 1, wherein a degree of a respective error of the MS gate is determined and controlled in a manner non-overlapping with other error types.

24. The computer-implemented method in accordance with claim 1, further comprising:
calculating line data, to form lines of a plot from the estimates of quantum process imperfections in the quantum MS gate; and
determining a degree of error and a type of error of the quantum process imperfections from respective slopes of the lines of the plot.

25. The computer-implemented method in accordance with claim 24, wherein the type of error and the degree of error are determined to be independently correct by controlling certain MS gate parameters specific to the type of error and the degree or error.
